(19) United States
(12) Patent Application Publication
(10) Pub. No.: US 2025/0045662 A1
(43) Pub. Date: Feb. 6, 2025

(54) METHODS AND SYSTEMS FOR GUIDED WORKFLOW PROCESSING IN CLIENT SERVICE SOFTWARE APPLICATIONS

(71) Applicant: FMR LLC, Boston, MA (US)

(72) Inventors: Pei Yan Wu, Hollis, NH (US); Fredric Phillips Jacobs, Dorchester, MA (US); Gabriel Chino, Centerville, UT (US); Michael Edward Masscotte, Mansfield, MA (US); Joshua Forest Schum, St. Louis, MO (US); Aaron Douglas DiNardo, Franklin, MA (US)

(21) Appl. No.: 18/497,927

(22) Filed: Oct. 30, 2023

Related U.S. Application Data
(60) Provisional application No. 63/529,920, filed on Jul. 31, 2023.

(51) Int. Cl. G06Q 10/0633

(52) U.S. Cl. CPC G06Q 10/0633

(57) ABSTRACT

Computerized methods and apparatuses, including computer program products, for guided workflow processing include a server computing device which determines a guided workflow transaction path based upon input received from a first client device. The server initiates a transaction based upon the transaction path, including capturing data elements associated with a user of a second client device. The server stores the captured data elements, including a transaction identification token and a state of the transaction path. The server receives a request to continue the transaction from the second client device and retrieves the data elements. The server generates a user interface form based upon the state of the transaction path and displays the user interface form on the second client device. The server processes the transaction based upon input received from the second client device via the user interface form.

### RELATED APPLICATION(S)

This application claims priority to U.S. Provisional Patent Application No. 63/529,920, filed on Jul. 31, 2023, the entirety of which is incorporated herein by reference.

### TECHNICAL FIELD

This application relates generally to methods and apparatuses, including computer program products, for guided workflow processing in client service software applications.

### BACKGROUND

To improve efficiency and reduce the amount of live assistance required, many organizations have developed web-based applications and portals that provide for self-service functions where customers can interact with the system and complete tasks without the need for specialized customer service assistance. However, because such technology is configured for customer self-service, associates that interact with customers face-to-face (e.g., employees in a branch location) are often unable to use the same web-based applications to assist the customers. For example, the same functions that exist in the self-service infrastructure must be separately built out for associate use (often with new technology or applications) and transactions must be replicated. Also, in some industries, governmental regulations or security guidelines prevent associates from assisting customers when personally identifiable information or other sensitive/private data may be exposed.

In addition, client associates may not be properly trained in the use of such computing systems and/or transactions for clients—for example, the client associate may not have performed a specific type of transaction before, the technology used to conduct the transaction could have changed recently, or compliance constraints may cause the representative to be unsure about what steps to take. As can be appreciated, these decisions multiply the complexity in an already complex landscape. With many choices to accomplish the same task in different ways, knowing when, why, and how to use specific tools to perform specific transactions on behalf of the client can be overwhelming.

### SUMMARY

Therefore, what is needed are guided service methods, systems and computerized tools that automatically prefill transactions (that were historically only client self-service) into client service application workflows so that clients need to just review relevant information and approve. The unique design of the guided service methods and systems described herein enables existing application assets to easily integrate with the guided service framework, which enables the associate to initiate automatic functions that prefill forms and fields for a client. Advantageously, a client representative does not need to leave the guided service framework, because the system provides user interface overlay configuration files by leveraging existing web application flows. This allows developers and software personnel to build once for customer and employee—increasing speed to market, reducing internal applications (maintenance, support), and obviating the need to obtain associate mindshare for new integrations introduced to associates or other digital pathways.

The invention, in one aspect, features a system for guided workflow processing in client service software applications. The system includes a server computing device with a memory for storing computer-executable instructions and a processor that executes the computer-executable instructions. The server computing device determines a guided workflow transaction path in a client service software application based upon input received from a first client computing device, including displaying a user interface associated with the guided workflow transaction path on the first client computing device. The server computing device initiates a transaction based upon the guided workflow transaction path, including capturing one or more data elements associated with a user of a second client computing device via the displayed user interface. The server computing device stores the captured data elements in a data structure for the transaction, the data structure including a transaction identification token and a state of the guided workflow transaction path. The server computing device receives a request to continue the transaction from the second client computing device. The server computing device retrieves the data structure for the transaction upon authenticating the user of the second client computing device. The server computing device generates a web-based user interface form based upon the state of the guided workflow transaction path, the web-based user interface form comprising the captured data elements from the retrieved data structure. The server computing device displays the web-based user interface form on the second client computing device. The server computing device processes the transaction based upon input received from the second client computing device via the web-based user interface form, including updating the state of the guided workflow transaction path upon processing the transaction.

The invention, in another aspect, features a computerized method of guided workflow processing in client service software applications. A server computing device determines a guided workflow transaction path in a client service software application based upon input received from a first client computing device, including displaying a user interface associated with the guided workflow transaction path on the first client computing device. The server computing device initiates a transaction based upon the guided workflow transaction path, including capturing one or more data elements associated with a user of a second client computing device via the displayed user interface. The server computing device stores the captured data elements in a data structure for the transaction, the data structure including a transaction identification token and a state of the guided workflow transaction path. The server computing device receives a request to continue the transaction from the second client computing device. The server computing device retrieves the data structure for the transaction upon authenticating the user of the second client computing device. The server computing device generates a web-based user interface form based upon the state of the guided workflow transaction path, the web-based user interface form comprising the captured data elements from the retrieved data structure. The server computing device displays the web-based user interface form on the second client computing device. The server computing device processes the transaction based upon input received from the second client computing device via the web-based user interface form, including updating the state of the guided workflow transaction path upon processing the transaction.

Any of the above aspects can include one or more of the following features. In some embodiments, the server computing device, the first client computing device, and the second client computing device are coupled to each other via a web server computing device that hosts the client service software application. In some embodiments, the user interface associated with the guided workflow transaction path comprises a webpage of the client service software application. In some embodiments, the web-based user interface form displayed on the second client computing device comprises the webpage of the client service software application.

In some embodiments, retrieving the data structure for the transaction upon authenticating the user of the second client computing device comprises identifying the user of the second client computing device based upon authentication credentials in the request; authenticating the user of the second client computing device by validating the authentication credentials; determining one or more in-process transactions based upon the user identity; selecting one of the in-process transactions associated with a transaction identification token in the request; and retrieving the data structure for the in-process transaction. In some embodiments, a user of the first client computing device is authenticated before determining the guided workflow transaction path.

In some embodiments, the guided workflow transaction path corresponds to an electronic document signature workflow. In some embodiments, capturing one or more data elements associated with a user of a second client computing device via the displayed user interface comprises receiving a user identifier associated with the user of the second client computing device via the displayed user interface; and retrieving the one or more data elements associated with the user of the second client computing device from a data store based upon the user identifier. In some embodiments, the server computing device transmits a signature request notification to the second client computing device upon storing the captured data elements in the data structure for the transaction.

In some embodiments, the second client computing device transmits the request to continue the transaction to the server computing device upon activation of the notification by the user of the second client computing device. In some embodiments, processing the transaction based upon input received from the second client computing device via the web-based user interface form comprises generating an electronic document signed by the user of the second client computing device, the electronic document comprising the captured data elements from the retrieved data structure; and updating the state of the guided workflow transaction path as completed. In some embodiments, the server computing device transmits a copy of the generated electronic document to the second client computing device upon processing the transaction.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for guided workflow processing in client service software applications.

FIG. 2 is a flow diagram of a computerized method of guided workflow processing in client service software applications.

FIG. 3 is a diagram of an exemplary user interface screen for initiation of a guided transaction workflow.

FIG. 4 is a diagram of an exemplary user interface screen for selection of a guided transaction workflow.

FIG. 5 is a diagram of an exemplary user interface screen for initiating an account opening transaction.

FIG. 6 is a diagram of an exemplary user interface screen for selecting an account type during an account opening transaction.

FIGS. 7A and 7B are diagrams of an exemplary user interface screen for capturing customer identification information during an account opening transaction.

FIGS. 8A and 8B are diagrams of an exemplary user interface screen for capturing customer employment information during an account opening transaction.

FIG. 9 is a diagram of an exemplary user interface screen for displaying captured customer information for review and submission during an account opening transaction.

FIG. 10 is a diagram of an exemplary transaction information data structure as stored in workflow data store.

FIG. 11 is a diagram of an exemplary web-based user interface form for displaying account opening information for review and approval during an account opening transaction.

FIG. 12 is a diagram of an exemplary workflow for conducting a guided transaction workflow.

### DETAILED DESCRIPTION

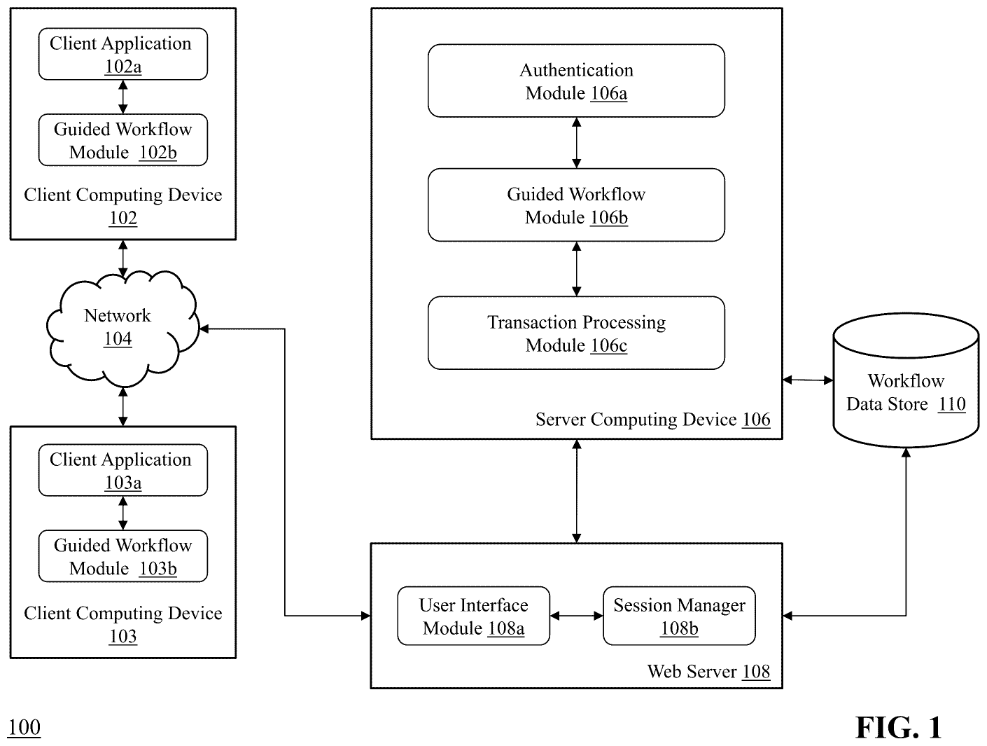

FIG. 1 is a block diagram of system 100 for guided workflow processing in client service software applications. System 100 includes client computing device 102 with client application 102a and guided workflow module 102b, client computing device 103 with client application 103a and guided workflow module 103b, communication network 104, server computing device 106 with authentication module 106a, guided workflow module 106b, and transaction processing module 106c, web server 108 with user interface (UI) module 108a and session manager 108b, and workflow data store 110.

Client computing devices 102, 103 connect to communication network 104 in order to communicate with web server 108 to interact with web applications hosted by web server 108 and participate in one or more sessions that can comprise guided transaction workflow processing. As can be appreciated, web server 108 can be configured to host one or more websites or web applications, and/or connect to other computing devices that provide web-related content to client computing devices 102, 103. For example, client computing devices 102, 103 can establish a communication session with UI module 108a and session manager 108b of web server 108 (e.g., via HTTP or HTTPS) using a uniform resource locator (URL) assigned to web server 108 and receive website and/or web application content from web server 108. A user at client computing device 102, 103 can interact with (e.g., browse) the website by activating links and navigating through various pages of the website. In some embodiments, each page or section of the website is associated with a particular URL. In some embodiments, client computing devices 102, 13 are each coupled to an associated display device (not shown). For example, client application 102a of client computing device 102 can provide a graphical user interface (GUI) via the display device that is configured to receive input from a user of the corresponding device 102 and to present output (e.g., web application content) to that user. In some embodiments, one or more of client computing devices 102, 103 can be configured to connect to server computing device 106 via network 104.

Exemplary client computing devices 102, 103 include but are not limited to desktop computers, laptop computers, tablets, mobile devices, smartphones, and internet appliances. It should be appreciated that other types of computing devices that are capable of connecting to the components of system 100 can be used without departing from the scope of invention. Although FIG. 1 depicts two client computing devices 102, 103, it should be appreciated that system 100 can include any number of client computing devices. In some embodiments, a user of client computing device 102 is a customer that intends to execute one or more transaction workflows and a user of client computing device 103 is a customer service representative (CSR) or other employee that assists the customer using a guided transaction workflow process as described herein. In some embodiments, client computing devices 102, 103 are in the same physical location (e.g., a branch office) while in other embodiments, client computing devices 102, 103 are in separate physical locations.

Communication network 104 enables client computing devices 102, 103 to communicate with web server 108. Network 104 is typically a wide area network, such as the Internet and/or a cellular network. In some embodiments, network 104 is comprised of several discrete networks and/or sub-networks (e.g., cellular to Internet).

Server computing device 106 is a device including specialized hardware and/or software modules that execute on a processor and interact with memory modules of server computing device 106, to receive data from other components of system 100, transmit data to other components of system 100, and perform functions for guided workflow processing in client service software applications as described herein. Server computing device 106 includes authentication module 106a, guided workflow module 106b, and transaction processing module 106c that execute on one or more processors of server computing device 106. In some embodiments, modules 106a-106c are specialized sets of computer software instructions programmed onto one or more dedicated processors in server computing device 106 and can include specifically-designated memory locations and/or registers for executing the specialized computer software instructions.

Although modules 106a-106c are shown in FIG. 1 as executing within the same server computing device 106, in some embodiments the functionality of modules 106a-106c can be distributed among a plurality of server computing devices. As shown in FIG. 1, server computing device 106 enables modules 106a-106c to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. Exemplary functionality of modules 106a-106c is described in detail throughout the specification.

Web server 108 is a computing device (or set of computing devices) to which client computing devices 102, 103 can connect to interact with content (such as web pages and/or web application functionality) provided by web server 108. In some embodiments, web server 108 is a combination of hardware, including one or more special-purpose processors and one or more physical memory modules, and specialized software modules (such as UI module 108a and session manager 108b) that are executed by one or more processors of web server 108. Typically, a website or web application comprises a plurality of visual and non-visual elements that make up content transmitted and displayed to a user when client applications 102a, 103a (such as browser software) on client computing devices 102, 103 connects to web server 108 via communication network 104 (e.g., Internet) and requests content or application functionality from web server 108. The elements of a website include, but are not limited to, webpages (e.g., HTML documents), image files, layouts, color sets, stylesheets, forms, document object models (DOM), tracking elements, metadata, URLs, and content (e.g., text, audio, video). As can be understood, in some embodiments each page of a website is associated with a particular URL that identifies the page's location and provides a mechanism for retrieving the page for display on client computing devices 102, 103. User interface (UI) module 108a is configured to generate user interface elements (such as pages, forms, and other web application features) for display on client computing devices 102, 103 via client applications 102a, 103a respectively. Session manager 108b is configured to establish browsing sessions with client computing devices 102, 103 and record session-related information (such as pages visited, URLs accessed, timestamps, page sequencing, and the like) for each user/client device.

Workflow data store 110 is located on a computing device (or in some embodiments, on a set of computing devices) coupled to server computing device 106 and/or web server 108. In some embodiments, workflow data store 110 is configured to receive, generate, and store specific segments of data relating to the process of guided workflow processing in client service software applications as described herein. In some embodiments, all or a portion of workflow data store 110 can be integrated with server computing device 106, web server 108, or be located on a separate computing device or devices. Workflow data store 110 can comprise one or more databases configured to store portions of data used by the other components of system 100. In some embodiments, workflow data store 110 comprises a data lake, data warehouse, or other large-scale repository for guided workflow transaction data.

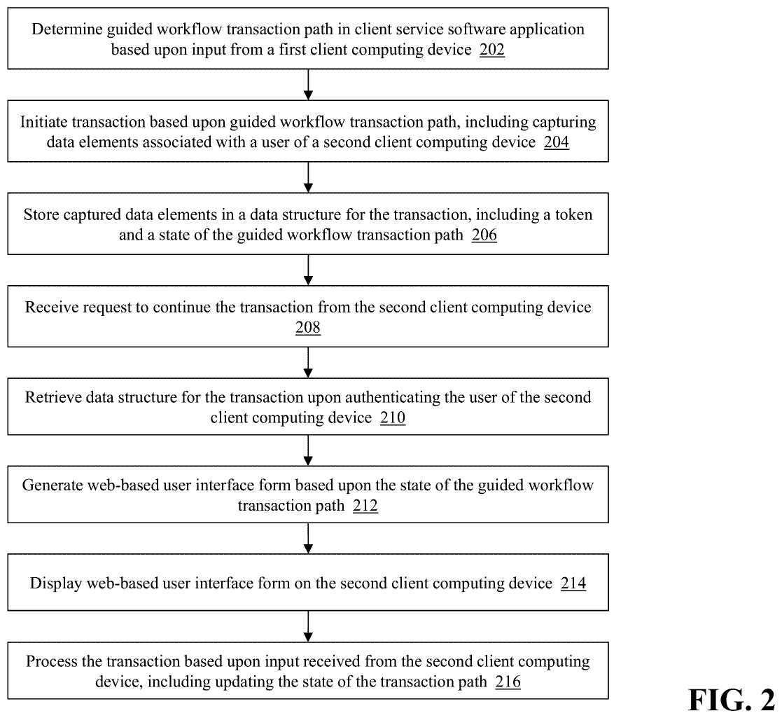

FIG. 2 is a flow diagram of a computerized method 200 of guided workflow processing in client service software applications, using system 100 of FIG. 1. As described above, system 100 can be configured to enable end users (such as customers and CSRs) to initiate and complete guided workflow transactions. In one example, a customer may visit a branch office of their financial institution to perform one or more transactions (e.g., account opening, trading, funds transfer, etc.) with the assistance of a CSR. In another example, the customer may access the financial institution's website via a personal computing device to perform one or more transactions. In yet another example, a CSR may initiate one or more transactions on behalf of a customer (e.g., upon receiving instructions from the customer via a telephone conversation). In any of these examples, the techniques described herein can advantageously provide for a streamlined and efficient transaction process whereby system users are directed to application resources that match their desired objectives using guided workflow processing and the ability to maintain transaction flows to seamlessly continue in-process transactions from the most recent transaction state.

A user (e.g., CSR) at a first client computing device 102 launches client application 102a to establish a connection between client device 102 and web server 108. User interface module 108a of web server 108 generates a user interface screen for display on first client computing device 102 to request information from the user that will initiate the guided workflow processing. In some embodiments, web server 108 connects to server computing device 106 during generation of the user interface screen to invoke guided workflow module 106b, which provides one or more guided workflow functions, input elements, overlays, and/or other assets that are incorporated into the user interface screen. In some embodiments, web server 108 invokes authentication module 106a of server computing device 106 upon establishing the connection with the first client computing device 102. Authentication module 106a is configured to request authentication credentials from the user of the first client computing device 102 and validate the credentials in order to verify the identity of the user and determine a set of guided workflow processing application functionality to which the user has access. For example, authentication module 106a can query workflow data store 110 to retrieve user profile information for the user upon successful authentication. The user profile information can comprise a plurality of data elements, such as user ID, job title, job role, guided workflow permissions, transaction permissions, etc. Authentication module 106a can pass the user profile information to user interface module 108a and/or guided workflow module 106b for configuration of the user interface screen presented to the user of the first client computing device 102.

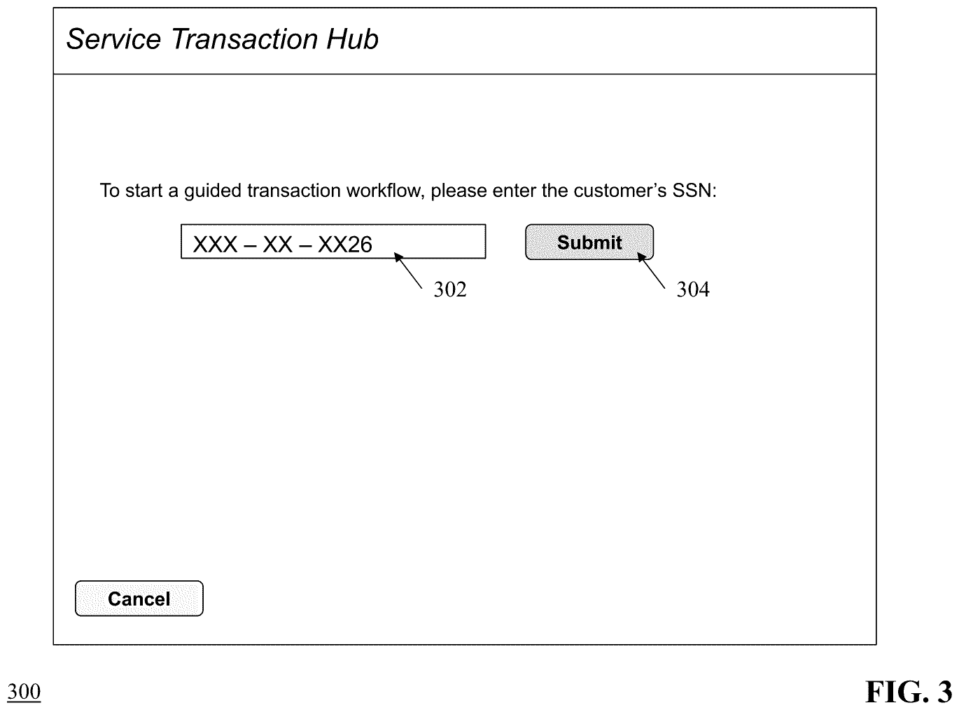

FIG. 3 is a diagram of an exemplary user interface screen 300 for initiation of a guided transaction workflow, as generated by UI module 108a of web server 108. As shown in FIG. 3, user interface 300 includes an input area 302 that enables the user of first client computing device 102 to enter identifying information for the customer that the user is assisting. For example, when a customer is visiting a branch location for in-person assistance from a CSR or the customer is on a voice call with the CSR, the CSR can ask the customer for their SSN and enter it into the input area 302. The CSR then interacts with button 304 to submit the identifying information to guided workflow module 106b of server computing device 106 for initiation of the guided transaction workflow.

Guided workflow module 106b uses the identifying information to retrieve additional information associated with the customer that will be used during the transaction workflow. In some embodiments, guided workflow module 106b accesses user profile data stored in, e.g., database 110 and/or another data source. The user profile data can include a variety of different data elements, such as: customer ID, customer name, mailing address, employment information, account number(s), account balances, demographic information, interaction history, and other similar types of information.

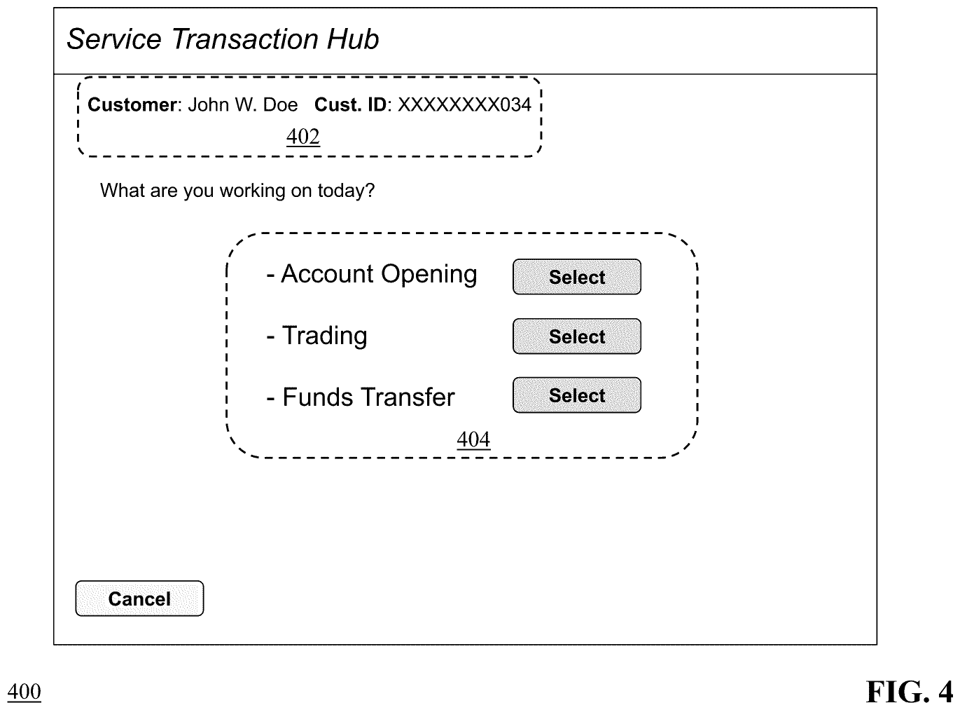

Upon capturing the customer profile information as described above, guided workflow module 106b determines one or more available guided workflow transactions to be completed for the customer. In some embodiments, guided workflow module 106b can analyze the customer profile information to determine the guided workflow transactions that are available to be completed. For example, module 106b can analyze the customer's interaction history (such as session logs for browsing sessions between the customer's computing device and the web server) and determine that the customer had recently been browsing the institution's website for information about opening a brokerage account. In another example, module 106b can analyze the customer's current account positions and/or portfolio holdings, and identify that the customer may want to rebalance the assets in their retirement account. Based upon this analysis, module 106b can select one or more guided workflow transactions and display them to the user of the first client computing device 102. FIG. 4 is a diagram of an exemplary user interface screen 400 for selection of a guided transaction workflow, as generated by UI module 108a of web server 108 and guided workflow module 106b of server computing device 106. As shown in FIG. 4, user interface 400 includes a display area 402 that includes at least a portion of the customer-identifying information (e.g., name, customer ID) that was retrieved by guided workflow module 106b as described above. The user interface 400 also includes a list 404 of guided workflow transactions available for completion. The CSR can interact with one of the buttons adjacent to the desired transaction in order to start the guided workflow for the transaction.

Upon selecting a guided workflow transaction, guided workflow module 106b determines (step 202) a guided workflow transaction path in client service software application based upon input from a first client computing device. As can be appreciated, each guided workflow transaction includes a transaction path data structure comprising a series of actions and associated application functions to be completed as part of the guided workflow transaction. In some embodiments, the transaction path is structured as a tree workflow where the first step of the workflow is represented as a root node and one or more branches representing actions and outcomes from the actions extend from the root node to one or more additional nodes. Module 106b can traverse the data structure to arrive at a terminating child node that represents completion of the transaction. Another important feature of the guided workflow transaction path is the ability to maintain and track a current state of the transaction based upon, e.g., the node in the guided workflow transaction path which is currently being processed by module 106b-so that the transaction can be saved and continued to completion on any number of different devices. In some embodiments, guided workflow module 106b maintains a record of the current state of the transaction path (including but not limited to completed nodes, incomplete nodes, and currently active node) so when the guided workflow transaction is continued on another device, module 106b can quickly configure the user interface and application functions to continue from the point at which the transaction was most recently updated or accessed.

After determining the guided workflow transaction path, guided workflow module 106b initiates (step 204) a transaction based upon the guided workflow transaction path. In the example provided herein, the CSR has selected an account opening transaction. Guided workflow module 106b starts the account opening transaction by instantiating a copy of the guided workflow transaction path associated with the account opening transaction and processing the root node of the transaction path. For example, the root node of the transaction path can comprise a URL for content/application functionality hosted by web server 108 (e.g., a webpage). Module 106b can redirect client application 102a of the first client computing device 102 to the URL defined in the root node in order for the CSR to begin the transaction. In some embodiments, the root node also comprises programmatic instructions for guided workflow module 106b to, e.g., capture one or more customer-specific and/or transaction-specific data elements for generation and storage of a specific data structure for the transaction that is used by module 106b used during the guided workflow. For example, the data structure can comprise customer-specific data elements (e.g., name, ID, address, demographics, etc.) that were previously retrieved by module 106b. The data structure can further comprise the current state of the guided workflow transaction path (e.g., an ID number of the selected transaction path and an ID number of the active node in the path) to enable module 106b to retrieve the guided workflow transaction path and traverse to the correct node to continue an in-process transaction. In some embodiments, module 106b also generates a transaction identifier that uniquely identifies the transaction.

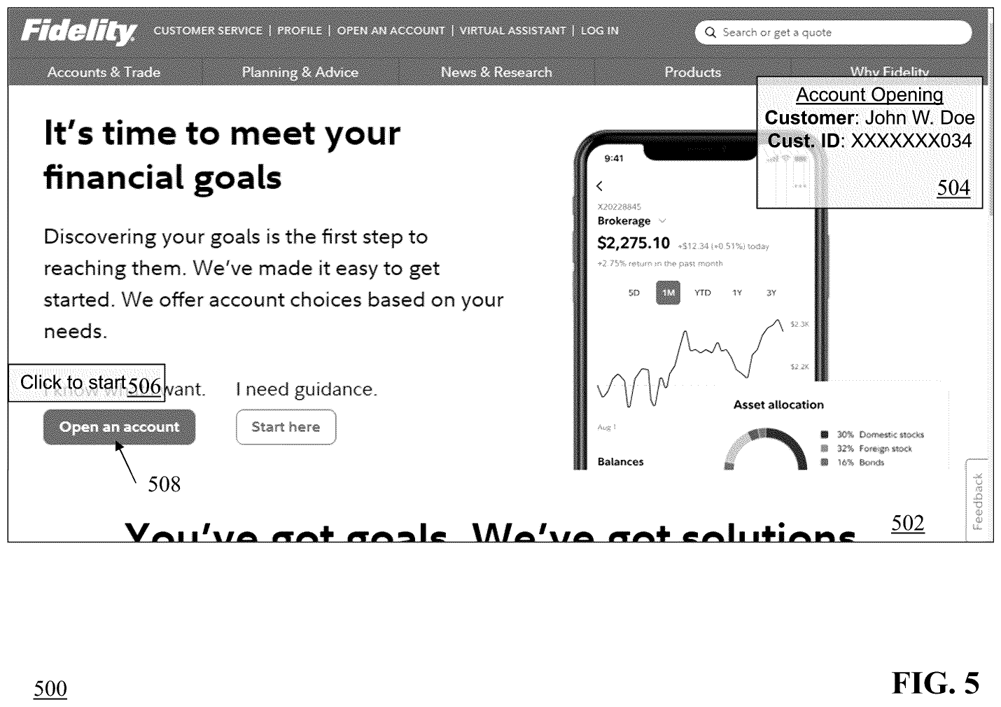

After configuration of the transaction path and transaction data structure as described above, guided workflow module 106b processes the root node of the transaction path to generate a user interface screen that is presented to the CSR at client computing device 102 to start the guided workflow transaction. FIG. 5 is a diagram of an exemplary user interface screen 500 for initiating an account opening transaction, as generated by UI module 108a of web server 108 and guided workflow module 106b of server computing device 106. As shown in FIG. 5, the user interface 500 includes a webpage 502 that displays button 504 for opening an account. As can be appreciated, webpage 502 can comprise content hosted by web server 108 that is generally available to internal and external users outside of the guided workflow processing described herein. Advantageously, by coordinating the display of user interface content with web server 108, guided workflow module 106b can re-use existing web assets or web application functionality that are served by web server 108 without having to create a separate application for guided transactions.

User interface 500 further includes overlay elements 504, 506 that are generated by guided workflow module 106b and/or UI module 108a as part of the guided workflow transaction path. In some embodiments, the active node of the transaction path comprises programmatic instructions that are processed by module 106b and/or module 108a to generate overlay elements 504, 506 and integrate the elements into the client application 102a user interface for display to the user at client computing device 102. Overlay element 504 comprises data elements associated with the customer for whom the guided workflow transaction is being performed—such as customer name and customer ID-so that the CSR can easily confirm that they are acting on behalf of the correct customer. Overlay element 506 comprises a prompt that directs the CSR to interact with a specific UI element (i.e., button 508) in order to proceed with the account opening transaction. As can be appreciated, overlay elements provide clear information and action steps to the user of client computing device 102—such that even a user who does not have training or experience in performing specific transactions is guided step-by-step through the application workflow.

In some embodiments, upon loading user interface 500 on client computing device 102, guided workflow module 106b communicates the relevant transaction path information (e.g., via the stored transaction data structure) to guided workflow module 102b on client device 102 to coordinate traversal through the transaction path. For example, guided workflow module 102b can update the transaction data structure based upon input captured via client application 102a as the CSR is proceeding with the transaction on device 102. This embodiment can be particularly useful in the event that client computing device 102 is operating in an offline mode-local storage and updating of the transaction data structure ensures that the transaction integrity is maintained and when client device 102 reconnects to web server 108 and/or server computing device 106, the updated transaction data structure can be transmitted back to guided workflow module 106b.

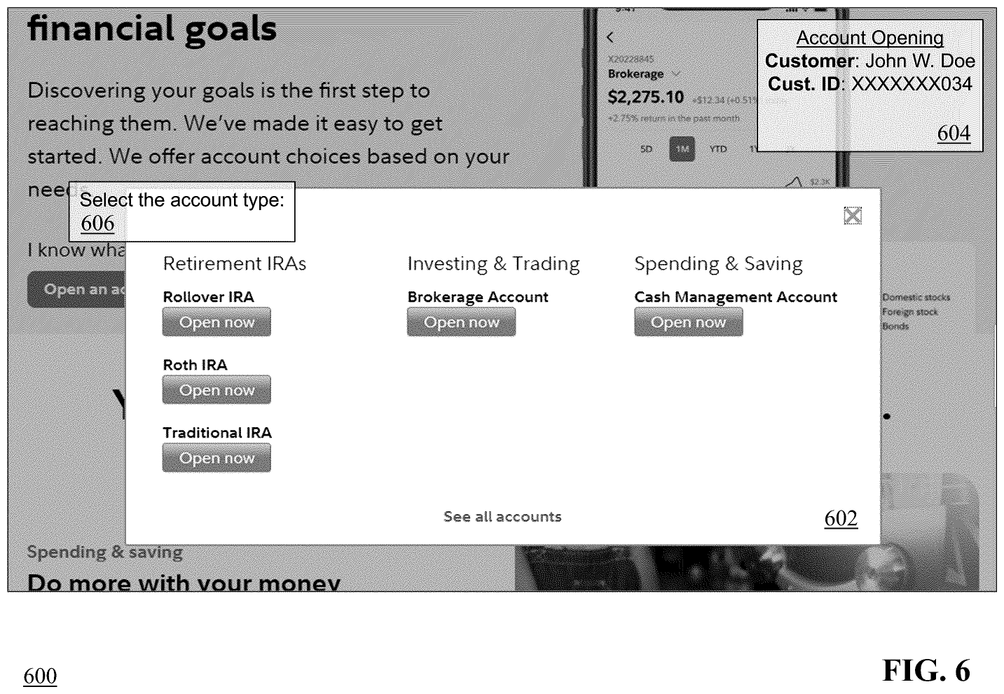

Upon detecting an interaction with button 508 from client computing device 102, guided workflow module 106b updates the state of the guided workflow transaction path (as stored in the transaction data structure) to match the current state of the account opening process and traverses a branch of the guided workflow transaction path data structure from, e.g., the root node to a child node that is connected to the root node. In this example, module 106b processes the child node to generate another user interface screen that is presented to the CSR at client computing device 102 in continuance of the account opening transaction workflow. FIG. 6 is a diagram of an exemplary user interface screen 600 for selecting an account type during an account opening transaction, as generated by UI module 108a of web server 108 and guided workflow module 106b of server computing device 106. As shown in FIG. 6, user interface 600 includes a display area 602 with a plurality of buttons, each corresponding to a different account type (e.g., IRA, Brokerage, Cash Management). User interface 600 also includes a plurality of overlay elements 604, 606 as generated by module 106b for integration into the underlying content served from web server 108. Overlay element 604 comprises data elements associated with the customer for whom the guided workflow transaction is being performed (similar to element 504 of FIG. 5). Overlay element 606 comprises a prompt that directs the CSR to interact with a specific UI element (i.e., one of the buttons in area 602) to continue the transaction. Also, upon loading user interface 600, guided workflow module 106b updates the state of the guided workflow transaction path (as stored in the transaction data structure) to match the current state of the account opening process.

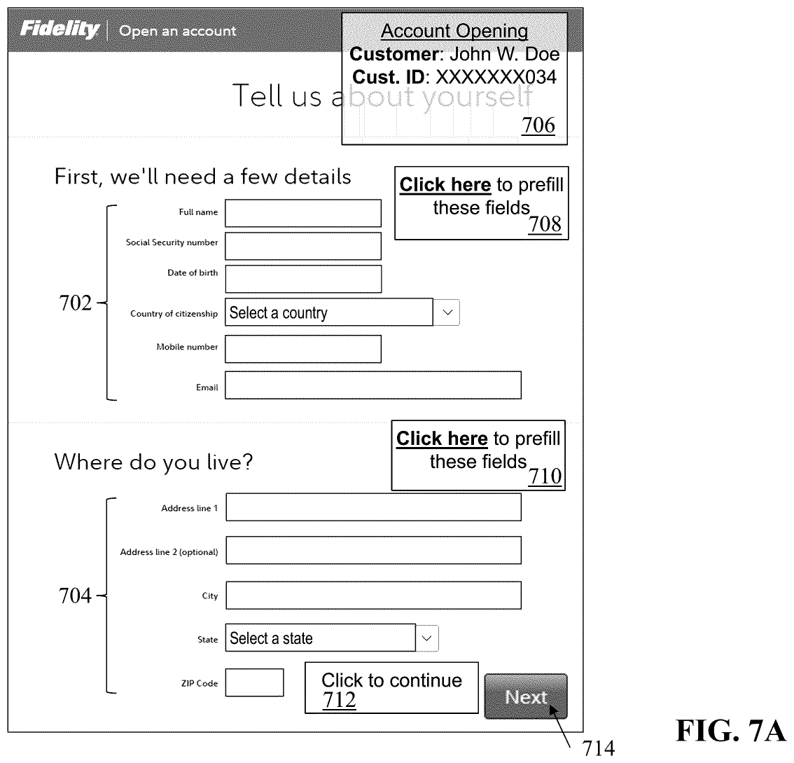

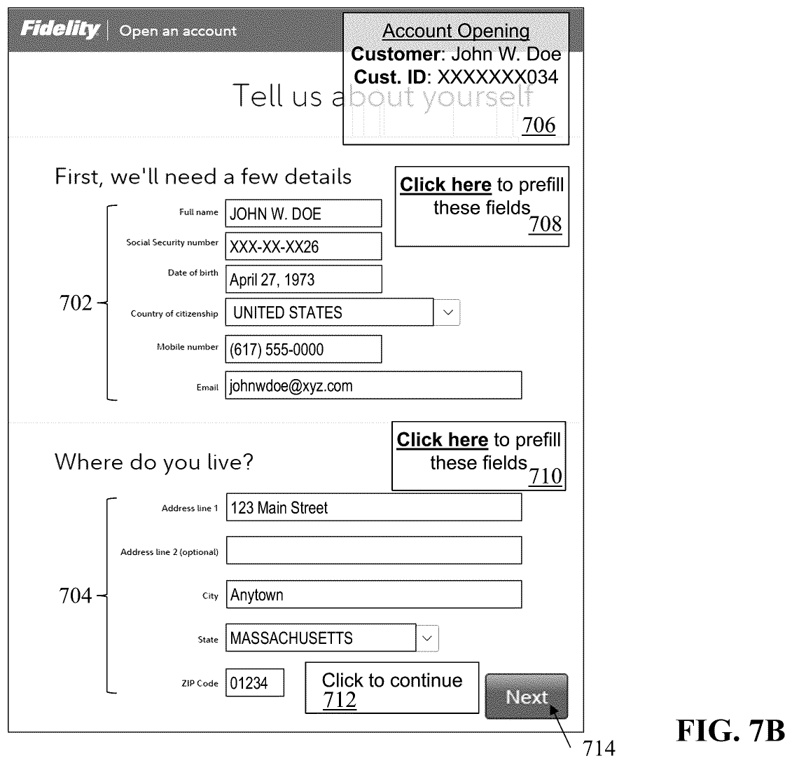

In this example, the CSR selects the button associated with the Brokerage Account. In response to the selection, guided workflow module 106b updates the state of the guided workflow transaction path (as stored in the transaction data structure) to match the current state of the account opening process and traverses a branch of the guided workflow transaction path data structure from, e.g., the current child node to another child node that is connected to the current child node. In this example, module 106b processes the new child node to generate another user interface screen that is presented to the CSR at client computing device 102 in continuance of the account opening transaction workflow. As can be appreciated, certain transactions may require the institution to capture certain customer-related information in order to complete the transaction. FIG. 7A is a diagram of an exemplary user interface screen 700 for capturing customer identification information during an account opening transaction, as generated by UI module 108a of web server 108 and guided workflow module 106b of server computing device 106. As shown in FIG. 7A, user interface 700 includes a display area 702 with input fields for certain customer details—such as name, SSN, date of birth, country, mobile number, and email address. User interface 700 also includes a display area 704 with input fields for the customer's mailing address.

Advantageously, the guided transaction workflow methods and systems described herein enable the user of client computing device 102 to pre-fill information into the relevant input fields 702, 704 based upon the data elements captured by module 106b as described above. User interface 700 includes a plurality of overlay elements 706, 708 and 710 as generated by module 106b for integration into the underlying content served from web server 108. Overlay element 706 comprises data elements associated with the customer for whom the guided workflow transaction is being performed (similar to element 504 of FIG. 5 and element 604 of FIG. 6). Overlay element 708 comprises a prompt that directs the CSR to pre-fill input fields 702 by clicking a link (e.g., ‘Click here’). Upon detecting interaction with the link in element 708, guided workflow module 106b retrieves data elements from the transaction data structure and/or from a user profile for the customer and populates the input fields 702 with the relevant data elements. In some embodiments, module 106b analyzes the guided workflow transaction path to identify a mapping between each input field 702 and a corresponding data element in the transaction data structure, then uses the mapping in order to populate the correct input fields. Similarly, overlay element 710 comprises a prompt that directs the CSR to pre-fill input fields 704 by clicking a link (e.g., ‘Click here’). FIG. 7B is a diagram of user interface 700 after the user at client computing device 102 has pre-filled the customer identification information. As shown in FIG. 7B, input fields 702 and 704 have been populated with customer data-which saves time for the CSR in completing the transaction and avoids potential data errors that could occur through manual entry. It should be appreciated that the CSR can optionally enter the data into user interface 700 and/or update one or more of the pre-populated fields based upon, e.g., new information provided by the customer. In these circumstances, guided workflow module 106b can automatically update the underlying data elements (e.g., in transaction data structure and/or the user profile data) so that the customer information is accurate. User interface 700 also includes overlay element 712 which comprises a prompt that directs the CSR to interact with a specific UI element (i.e., button 714) to continue the transaction.

Upon detecting an interaction with button 714 from client computing device 102, guided workflow module 106b updates the state of the guided workflow transaction path (as stored in the transaction data structure) to match the current state of the account opening process and traverses a branch of the guided workflow transaction path data structure from, e.g., the current child node to another child node that is connected to the current child node. In this example, module 106b processes the new child node to generate another user interface screen that is presented to the CSR at client computing device 102 in continuance of the account opening transaction workflow.

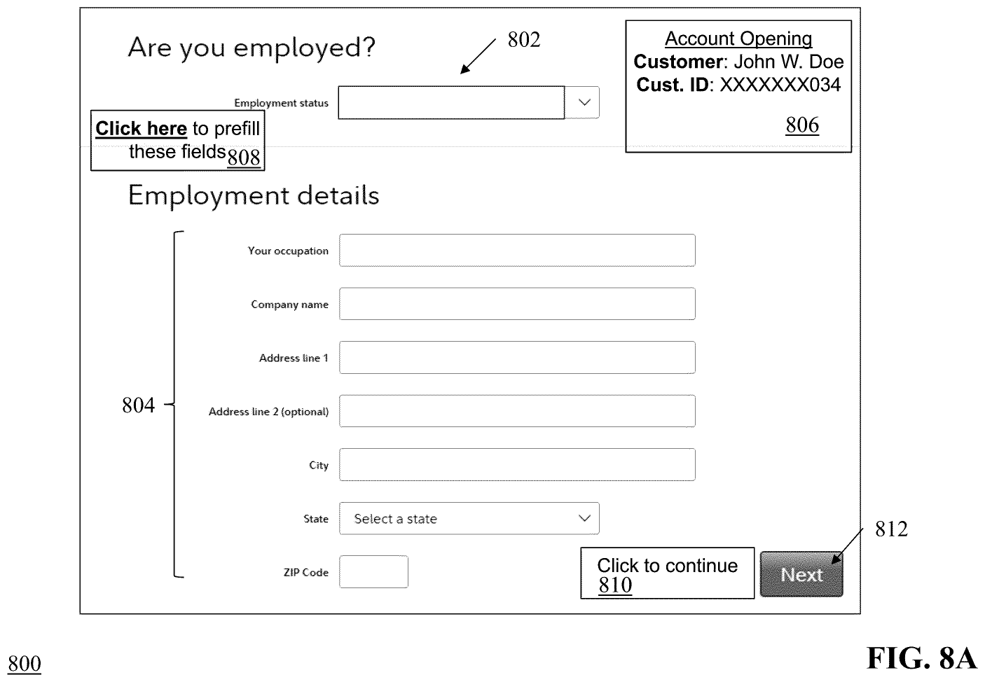

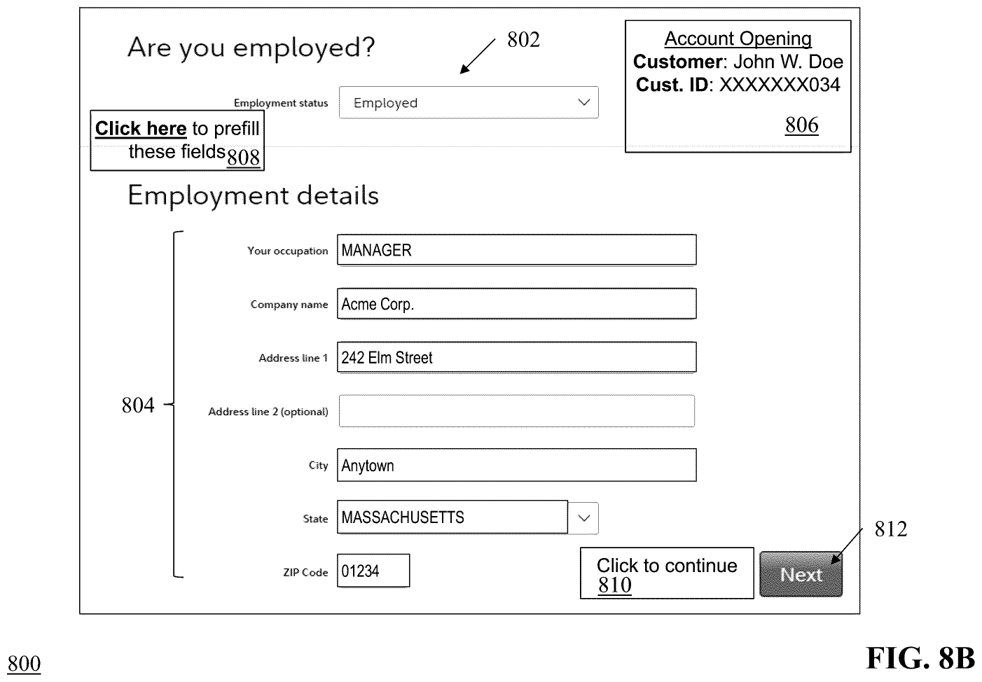

FIG. 8A is a diagram of an exemplary user interface screen 800 for capturing customer employment information during an account opening transaction, as generated by UI module 108a of web server 108 and guided workflow module 106b of server computing device 106. As shown in FIG. 8A, user interface 800 includes a display area 802 with an input field for employment status and a display area 804 with input fields for customer employment information—such as occupation, company name and address. User interface 700 also includes a display area 704 with input fields for the customer's mailing address. User interface 700 includes a plurality of overlay elements 806 and 808 as generated by module 106b for integration into the underlying content served from web server 108. Overlay element 806 comprises data elements associated with the customer for whom the guided workflow transaction is being performed (similar to element 504 of FIG. 5, element 604 of FIG. 6, and element 706 of FIG. 7A). Overlay element 808 comprises a prompt that directs the CSR to pre-fill input fields 802 and 804 by clicking a link (e.g., ‘Click here’). Upon detecting interaction with the link in element 808, guided workflow module 106b retrieves data elements from the transaction data structure and/or from a user profile for the customer and populates the input fields 802 and 804 with the relevant data elements. In some embodiments, module 106b analyzes the guided workflow transaction path to identify a mapping between each input field 802 and 804 and a corresponding data element in the transaction data structure, then uses the mapping in order to populate the correct input fields. FIG. 8B is a diagram of user interface 800 after the user at client computing device 102 has pre-filled the customer employment information. As shown in FIG. 8B, input fields 802 and 804 have been populated with customer data-which saves time for the CSR in completing the transaction and avoids potential data errors that could occur through manual entry. It should be appreciated that the CSR can optionally enter the data into user interface 800 and/or update one or more of the pre-populated fields based upon, e.g., new information provided by the customer. In these circumstances, guided workflow module 106b can automatically update the underlying data elements (e.g., in transaction data structure and/or the user profile data) so that the customer information is accurate. User interface 800 also includes overlay element 810 which comprises a prompt that directs the CSR to interact with a specific UI element (i.e., button 812) to continue the transaction.

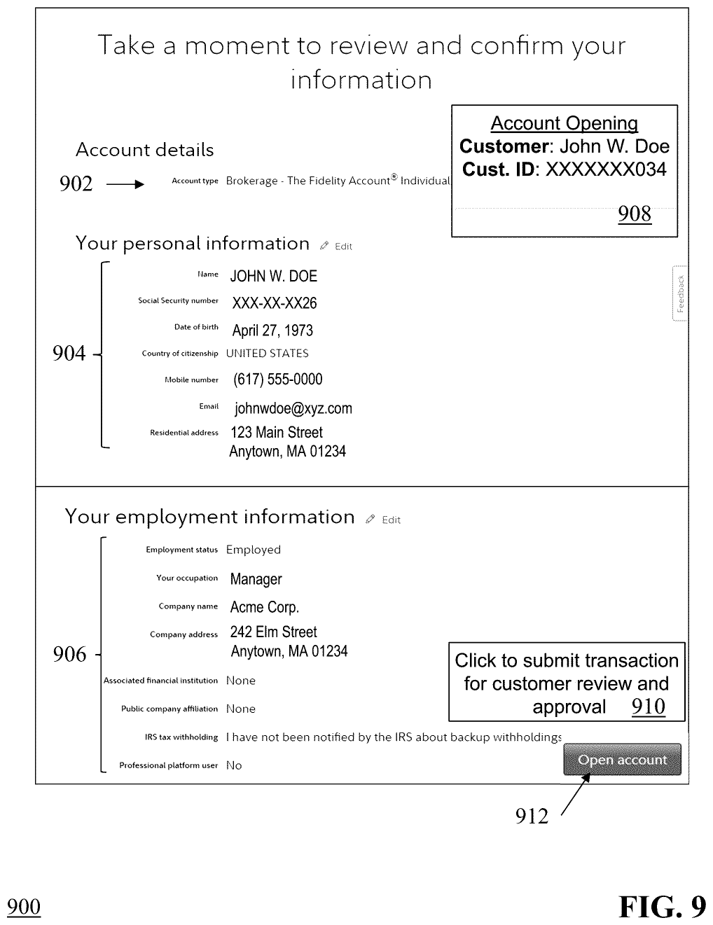

Upon detecting an interaction with button 812 from client computing device 102, guided workflow module 106b traverses a branch of the guided workflow transaction path data structure from, e.g., the current child node to another child node that is connected to the current child node. In this example, module 106b processes the new child node to generate another user interface screen that is presented to the CSR at client computing device 102 in continuance of the account opening transaction workflow. FIG. 9 is a diagram of an exemplary user interface screen 900 for displaying captured customer information for review and submission during an account opening transaction, as generated by UI module 108a of web server 108 and guided workflow module 106b of server computing device 106. As shown in FIG. 9, user interface 900 includes a display area 902 that includes the account type (“Brokerage”), a display area 904 that displays the captured customer identification information, and a display area 906 that displays the captured customer employment information. User interface 900 also includes a plurality of overlay elements 908 and 910 as generated by module 106b for integration into the underlying content served from web server 108. Overlay element 908 comprises data elements associated with the customer for whom the guided workflow transaction is being performed (similar to element 504 of FIG. 5, element 604 of FIG. 6, element 706 of FIG. 7A, and element 806 of FIG. 8A). The user at client computing device 102 can quickly review the information displayed in user interface 900 to confirm that the information is correct and complete. Overlay element 910 comprises a prompt that directs the CSR to interact with a specific UI element (i.e., button 912) to submit the account opening transaction for customer review and approval.

Upon detecting an interaction with button 912 from client computing device 102, guided workflow module 106b updates the state of the guided workflow transaction path (as stored in the transaction data structure) to match the current state of the account opening process and traverses a branch of the guided workflow transaction path data structure from, e.g., the current child node to another child node that is connected to the current child node. In this example, module 106b processes the new child node to store (step 206) the captured data elements in the transaction data structure (including the customer-specific data elements, the transaction-specific data elements, and the state of the guided workflow transaction path), as well as generating the transaction identifier for inclusion in the transaction data structure. In some embodiments, module 106b processes the child node to generate any transaction-specific data elements that are needed to continue the transaction, such as allocating a new account number to the transaction and/or performing any required identity validation steps or regulatory compliance steps. Guided workflow module 106b stores the transaction data structure in workflow data store 110 and continues the guided workflow transaction.

Once the transaction data structure is stored, guided workflow module 106b traverses a branch of the guided workflow transaction path data structure from, e.g., the current child node to another child node that is connected to the current child node. In this example, module 106b processes the new child node to transmit a notification to a second client computing device 103 associated with the customer. In some embodiments, the notification is an electronic message (e.g., email, text message, app alert) which informs the customer that action is required to complete the account opening process. In some embodiments, the notification message includes the transaction data structure previously stored for the transaction by module 106b as described above. In these embodiments, guided workflow module 103b on client computing device 103 can receive the transaction data structure for use in conjunction with client application 103a to continue the account opening transaction.

The customer at client computing device 103 can interact with the notification message, which directs client application 103a to transmit a request to web server 108. The request can comprise the transaction identifier, and/or other data elements associated with the customer or transaction. Web server 108 receives (step 208) the request to continue the transaction from the second client computing device 103 and invokes guided workflow module 106b to proceed with review and approval of the transaction. In some embodiments, upon detecting interaction with the notification message, guided workflow module 103b can locate and process the current node in the transaction path (based upon, e.g., the state of the transaction path as stored in the transaction data structure). The current node can comprise a URL associated with web server 108 that directs client application 103a to connect to web server 108 and receive specific content (e.g., a webpage) corresponding to the current node in the transaction path. Guided workflow module 103b can then update the state of the transaction path in the transaction data structure and transmit the updated data structure to guided workflow module 106b for continuing the account opening transaction.

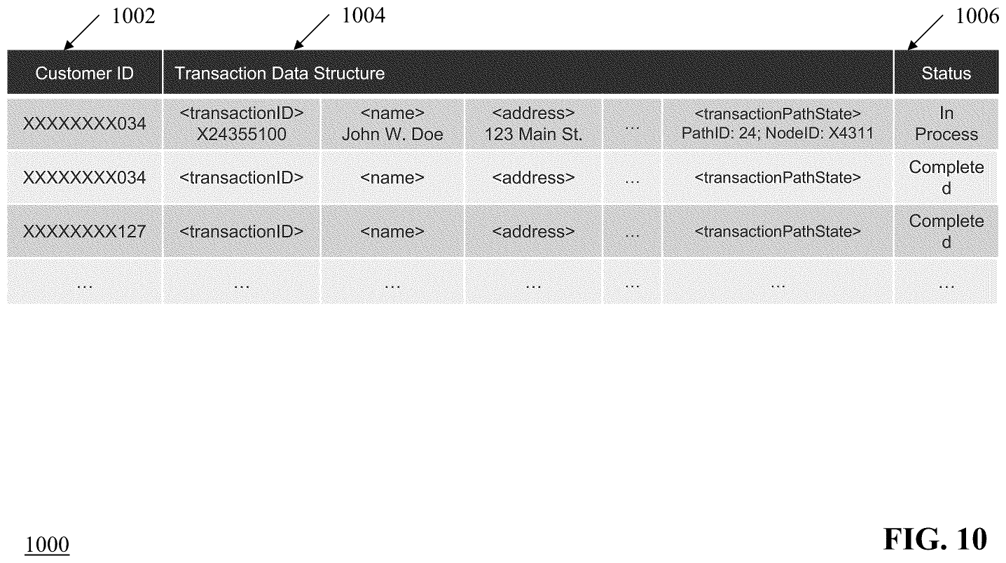

After receiving the request to continue the transaction, guided workflow module 106b retrieves (step 210) the corresponding transaction data structure from, e.g., workflow data store 110. In some embodiments, web server 108 invokes authentication module 106a of server computing device 106 upon establishing the connection with the second client computing device 103. Authentication module 106a is configured to request authentication credentials from the user of the second client computing device 103 and validate the credentials in order to verify the identity of the customer and determine a set of guided workflow processing application functionality to which the customer has access. For example, authentication module 106a can query workflow data store 110 to retrieve transaction information for the user upon successful authentication. FIG. 10 is a diagram of an exemplary transaction information data structure 1000 as stored in workflow data store 110. As shown in FIG. 10, data structure 1000 comprises the customer ID 1002, the transaction data structure 1004 (described above), and status 1006 (i.e., completed or in-progress). Authentication module 106a can provide ‘in process’ transaction information (including the corresponding transaction data structure(s) 1004) to user interface module 108a and/or guided workflow module 106b for configuration of the user interface screen presented to the customer at the second client computing device 103.

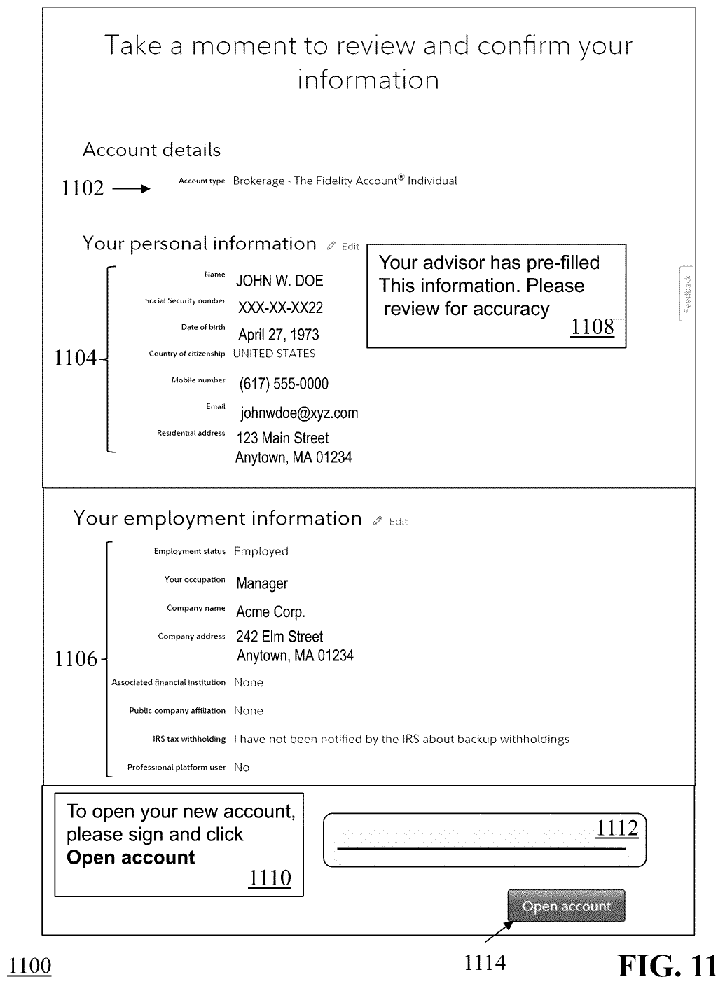

Upon retrieving the transaction data structure from data store 110, guided workflow module 106b traverses a branch of the guided workflow transaction path data structure (using the updated state provided by client computing device 103) from, e.g., the current child node to another child node that is connected to the current child node. In this example, module 106b processes the new child node to generate (step 212) a web-based user interface form based upon the state of the transaction path and display (step 214) the web-based user interface form to the customer at client computing device 103. The web-based user interface form includes at least a portion of the captured customer-specific and transaction-specific data elements from the retrieved transaction data structure. FIG. 11 is a diagram of an exemplary web-based user interface form 1100 for displaying account opening information for review and approval during an account opening transaction, as generated by UI module 108a of web server 108 and guided workflow module 106b of server computing device 106. As shown in FIG. 11, web-based user interface form 1100 includes a display area 1102 that includes the account type (“Brokerage”), a display area 1104 that displays the captured customer identification information, and a display area 1106 that displays the captured customer employment information (as previously pre-filled by the CSR at client computing device 102). Web-based user interface form 1100 also includes a plurality of overlay elements 1108 and 1110 as generated by module 106b for integration into the underlying content served from web server 108. Overlay element 1108 comprises a prompt that directs the customer to review the information displayed in areas 1102, 1104, and 1106 for accuracy. Overlay element 1110 comprises a prompt that directs the customer to interact with a specific UI element (i.e., signature field 1112) to sign the brokerage account application and click button 1114 to authorize the account opening transaction.

In some embodiments, web-based user interface form 1100 can comprise an electronic document (such as a web-based PDF) that includes static and dynamic form fields for interaction with the customer at client computing device 103. For example, web-based user interface form 1100 can be included within an e-signature framework which provides for the capture of an electronic signature from the customer in order to authorize the transaction.

Upon detecting an interaction with button 1114 from client computing device 102, guided workflow module 106b updates the state of the guided workflow transaction path (as stored in the transaction data structure) to match the current state of the account opening process and traverses a branch of the guided workflow transaction path data structure from, e.g., the current child node to another child node that is connected to the current child node. In this example, module 106b processes the new child node to (i) validate the customer's signature as provided in field 1112 and (ii) instruct transaction processing module 106c to execute the account opening transaction. In some embodiments, guided workflow module 106b can instruct authentication module 106a to compare the customer signature submitted via user interface 1100 with a stored image of the customer's signature to confirm that the signatures match. For example, authentication module 106a can perform an image comparison using the submitted signature image 1112 and the stored signature image to detect whether the submitted signature deviates from the stored signature. Depending upon a configured tolerance threshold (e.g., based upon a similarity measure between the images), authentication module 106a can determine that the signatures do not match and reject the transaction. Alternatively, authentication module 106a can determine that the signatures match and inform transaction processing module 106c to continue executing the account opening transaction.

Transaction processing module 106c of server computing device 106 processes (step 216) the transaction based upon the input received from the client computing device 103 (i.e., the customer signing the web-based user interface form in area 1112 and clicking button 1114). For example, module 106c connects to an account processing application (either provided by web server 108 or another computing device) and provides the relevant transaction details (e.g., customer information, account information, etc.) to the account processing application for creation of the new account. In some embodiments, module 106c can call an application programming interface (API) to trigger the account opening process. Also, at this stage, guided workflow module 106b traverses a branch of the guided workflow transaction path data structure from, e.g., the current child node to an end node that is connected to the current child node where the end node corresponds to completion of the account opening transaction. Module 106b updates the state of the guided workflow transaction path in the transaction data structure to correspond to the end node and changes the status of the transaction in data structure 1000 to ‘Completed.’

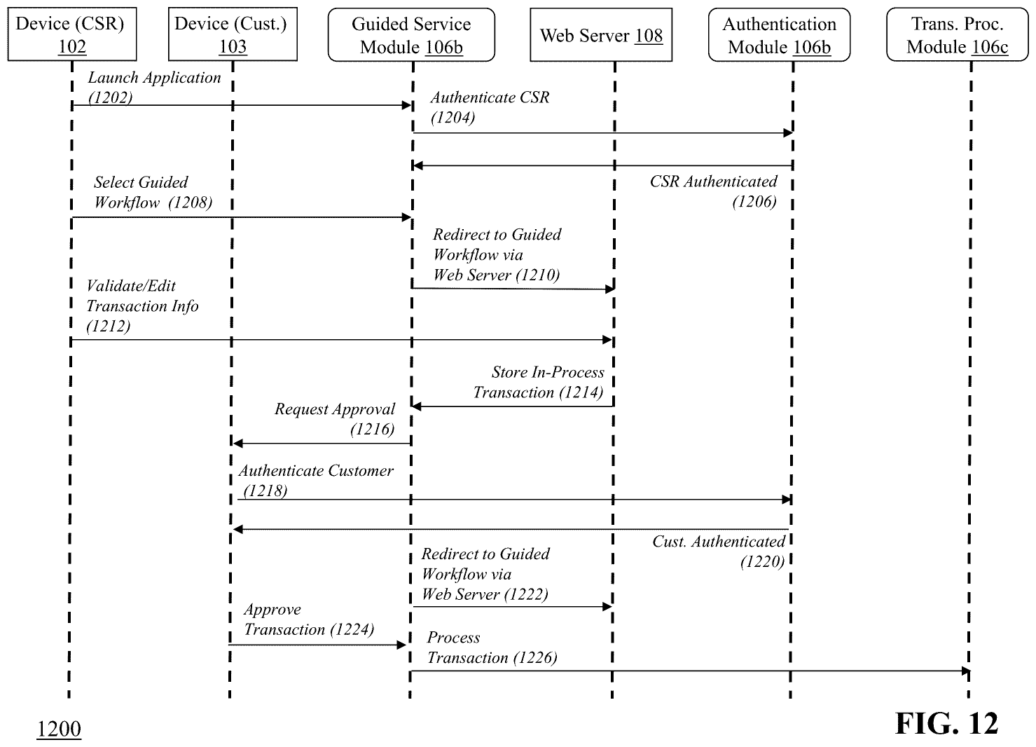

FIG. 12 is a diagram of an exemplary workflow 1200 for conducting a guided transaction workflow, using system 100 of FIG. 1. A user (e.g., CSR) at client computing device 102 launches (step 1202) client application 102a, which connects to guided service module 106b of server computing device 106. Guided service module 106b instructs authentication module 106a to authenticate (step 1204) the CSR. Once the CSR is authenticated (step 1206), guided service module 106b interacts with client computing device 102 to enable the CSR to select (1208) a guided transaction workflow, e.g., for a particular customer and/or transaction. Guided service module 106b redirects (step 1210) client computing device 102 to application functionality corresponding to the guided workflow as provided by web server 108, while also providing the guided workflow experience (including relevant overlays) as described herein. The CSR at client computing device 102 validates and/or edits (step 1212) the transaction information and web server 108 in conjunction with guided service module 106b stores (step 1214) the in-process transaction information in a transaction data structure. Guided service module 106b then requests (step 1216) approval for the transaction from client computing device 103 associated with the customer. Authentication module 106b authenticates (step 1218) the customer at client computing device 103 and, once the customer is authenticated (step 1220), guided service module 106b redirects (step 1222) client computing device 103 to application functionality corresponding to the current state of the guided workflow as provided by web server 108, while also providing the guided workflow experience (including relevant overlays) as described herein. The customer at client computing device 103 approves (step 1224) the transaction, and guided service module 106b instructs transaction processing module 106c to execute the transaction.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the technology by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for guided workflow processing in client service software applications, the system comprising a server computing device with a memory for storing computer-executable instructions and a processor that executes the computer-executable instructions to:
determine a guided workflow transaction path in a client service software application based upon input received from a first client computing device, including displaying a user interface associated with the guided workflow transaction path on the first client computing device;
initiate a transaction based upon the guided workflow transaction path, including capturing one or more data elements associated with a user of a second client computing device via the displayed user interface;
store the captured data elements in a data structure for the transaction, the data structure including a transaction identification token and a state of the guided workflow transaction path;
receive a request to continue the transaction from the second client computing device;
retrieve the data structure for the transaction upon authenticating the user of the second client computing device;
generate a web-based user interface form based upon the state of the guided workflow transaction path, the web-based user interface form comprising the captured data elements from the retrieved data structure;
display the web-based user interface form on the second client computing device; and
process the transaction based upon input received from the second client computing device via the web-based user interface form, including updating the state of the guided workflow transaction path upon processing the transaction.

2. The system of claim 1, wherein the server computing device, the first client computing device, and the second client computing device are coupled to each other via a web server computing device that hosts the client service software application.

3. The system of claim 2, wherein the user interface associated with the guided workflow transaction path comprises a webpage of the client service software application.

4. The system of claim 3, wherein the web-based user interface form displayed on the second client computing device comprises the webpage of the client service software application.

5. The system of claim 1, wherein retrieving the data structure for the transaction upon authenticating the user of the second client computing device comprises:
identifying the user of the second client computing device based upon authentication credentials in the request;
authenticating the user of the second client computing device by validating the authentication credentials;
determining one or more in-process transactions based upon the user identity;
selecting one of the in-process transactions associated with a transaction identification token in the request; and
retrieving the data structure for the in-process transaction.

6. The system of claim 1, wherein a user of the first client computing device is authenticated before determining the guided workflow transaction path.

7. The system of claim 1, wherein the guided workflow transaction path corresponds to an electronic document signature workflow.

8. The system of claim 7, wherein capturing one or more data elements associated with a user of a second client computing device via the displayed user interface comprises:
receiving a user identifier associated with the user of the second client computing device via the displayed user interface; and
retrieving the one or more data elements associated with the user of the second client computing device from a data store based upon the user identifier.

9. The system of claim 8, wherein the server computing device transmits a signature request notification to the second client computing device upon storing the captured data elements in the data structure for the transaction.

10. The system of claim 9, wherein the second client computing device transmits the request to continue the transaction to the server computing device upon activation of the notification by the user of the second client computing device.

11. The system of claim 10, wherein processing the transaction based upon input received from the second client computing device via the web-based user interface form comprises:
generating an electronic document signed by the user of the second client computing device, the electronic document comprising the captured data elements from the retrieved data structure; and
updating the state of the guided workflow transaction path as completed.

12. The system of claim 11, wherein the server computing device transmits a copy of the generated electronic document to the second client computing device upon processing the transaction.

13. A computerized method of guided workflow processing in client service software applications, the method comprising:
determining, by a server computing device, a guided workflow transaction path in a client service software application based upon input received from a first client computing device, including displaying a user interface associated with the guided workflow transaction path on the first client computing device;
initiating, by the server computing device, a transaction based upon the guided workflow transaction path, including capturing one or more data elements associated with a user of a second client computing device via the displayed user interface;
storing, by the server computing device, the captured data elements in a data structure for the transaction, the data structure including a transaction identification token and a state of the guided workflow transaction path;
receiving, by the server computing device, a request to continue the transaction from the second client computing device;
retrieving, by the server computing device, the data structure for the transaction upon authenticating the user of the second client computing device;
generating, by the server computing device, a web-based user interface form based upon the state of the guided workflow transaction path, the web-based user interface form comprising the captured data elements from the retrieved data structure;
displaying, by the server computing device, the web-based user interface form on the second client computing device; and
processing, by the server computing device, the transaction based upon input received from the second client computing device via the web-based user interface form, including updating the state of the guided workflow transaction path upon processing the transaction.

14. The method of claim 13, wherein the server computing device, the first client computing device, and the second client computing device are coupled to each other via a web server computing device that hosts the client service software application.

15. The method of claim 14, wherein the user interface associated with the guided workflow transaction path comprises a webpage of the client service software application.

16. The method of claim 15, wherein the web-based user interface form displayed on the second client computing device comprises the webpage of the client service software application.

17. The method of claim 13, wherein retrieving the data structure for the transaction upon authenticating the user of the second client computing device comprises:
identifying the user of the second client computing device based upon authentication credentials in the request;
authenticating the user of the second client computing device by validating the authentication credentials;
determining one or more in-process transactions based upon the user identity;
selecting one of the in-process transactions associated with a transaction identification token in the request; and
retrieving the data structure for the in-process transaction.

18. The method of claim 13, wherein a user of the first client computing device is authenticated before determining the guided workflow transaction path.

19. The method of claim 13, wherein the guided workflow transaction path corresponds to an electronic document signature workflow.

20. The method of claim 19, wherein capturing one or more data elements associated with a user of a second client computing device via the displayed user interface comprises:
receiving a user identifier associated with the user of the second client computing device via the displayed user interface; and
retrieving the one or more data elements associated with the user of the second client computing device from a data store based upon the user identifier.

21. The method of claim 20, wherein the server computing device transmits a signature request notification to the second client computing device upon storing the captured data elements in the data structure for the transaction.

22. The method of claim 21, wherein the second client computing device transmits the request to continue the transaction to the server computing device upon activation of the notification by the user of the second client computing device.

23. The method of claim 22, wherein processing the transaction based upon input received from the second client computing device via the web-based user interface form comprises:
generating an electronic document signed by the user of the second client computing device, the electronic document comprising the captured data elements from the retrieved data structure; and
updating the state of the guided workflow transaction path as completed.

24. The method of claim 23, wherein the server computing device transmits a copy of the generated electronic document to the second client computing device upon processing the transaction.
